(19) United States
(12) Patent Application Publication
(10) Pub. No.: US 2023/0228600 A1
(43) Pub. Date: Jul. 20, 2023

(54) DRAG POINTER FOR CALCULATING A PROCESS MEASUREMENT VARIABLE

(71) Applicant: VEGA Grieshaber KG, Wolfach (DE)

(72) Inventor: Guenter KECH, Wolfach (DE)

(73) Assignee: VEGA Grieshaber KG, Wolfach (DE)

(21) Appl. No.: 18/153,142

(22) Filed: Jan. 11, 2023

(30) Foreign Application Priority Data
Jan. 14, 2022 (EP) 22151515.8

(51) Int. Cl. G01D 13/24; G01D 13/26

(52) U.S. Cl. CPC G01D 13/24; G01D 13/26

(57) ABSTRACT

A drag pointer configured for calculating a process measurement variable including calculation circuitry for approximately calculating a past temporal development of the value of the process measurement variable from process measurement data of a measuring device, and for calculating the current value of the process measurement variable from the past temporal development.

### CROSS-REFERENCE TO RELATED APPLICATIONS

This application claims the benefit of the filing date of European Patent Application No. 22 151 515.8 filed on 14 Jan. 2022, the entire content of which is incorporated herein by reference.

### FIELD

The disclosure relates to process measurement technology. In particular, the disclosure relates to a drag pointer configured for calculating a process measurement variable, a measuring device comprising such a drag pointer, a measuring device-external display and/or evaluation unit comprising such a drag pointer, a method for calculating a process measurement variable, a program element and a computer-readable medium.

### TECHNICAL BACKGROUND

In modern process measurement technology, and especially when using stand-alone, non-cabled measuring instruments, the energy supply is often limited. Thus, it is necessary to find a compromise between, on the one hand, high measurement accuracy and, on the other hand, the lowest possible energy consumption. For example, measurement accuracy can be increased by taking as many individual measurements as possible, but this is associated with relatively high energy consumption. On the other hand, energy consumption can be reduced by measuring less frequently.

### SUMMARY

It is an object of the present disclosure to increase the accuracy in the output of values of process measurement variables.

This object is solved by the features of the independent patent claims. Further embodiments result from the subclaims and the following description of embodiments.

A first aspect relates to a drag pointer configured to calculate a process measurement variable. The drag pointer is, for example, a control unit located inside or outside the actual measurement device. For example, it may be arranged in the cloud, or in a cell phone or other device of a user.

The drag pointer has a calculation unit that is configured to approximately calculate a past temporal development of the value of the process measurand from process measurement data of a measuring device, as well as to calculate the current value of the process measurand from the past temporal (calculated) development.

The value of the process variable is, for example, a filling level, a pressure or a flow rate. Process measurement data means the actual measurement data that the measuring device records and which is then converted into the value of the process measurement variable.

In other words, the calculation unit is configured to calculate approximately the temporal development of the measured value (i.e., for example, the level, pressure or flow) from the past process measurement data of the measuring device. As a rule, this will result in a smooth, continuous temporal progression, and not a step-shaped progression defined by individual measuring points. From this temporal course, the computing unit can then calculate the current value of the process measurand. This is a forecast, prediction or estimation.

Approximating the past temporal development of the value of the process measurement variable includes, for example, recognizing a process measurand pattern or trend. For example, the computing unit may recognize that a fill level is increasing continuously and linearly because the container is being filled at a constant fill rate. Similarly, it can detect when the container is being emptied continuously and at a constant rate. Then, too, it will generate a straight line, but this time with a negative slope.

According to a further embodiment, the computing unit is configured to compare the calculated current value of the process measurand with a current value of the process measurand that is attributable to current process measurement data.

In other words, the computing unit can compare the (theoretical, predicted) calculated measured value with an actual measured value.

According to a further embodiment, the computing unit is configured to instruct the measuring device to transmit process measurement data to an external receiver if the calculated current value of the process measurement variable deviates from the current value of the process measurement variable attributable to the current process measurement data by more than a predetermined threshold value.

The measuring device therefore only transmits new, current process measurement data to the external receiver if the last measured value deviates significantly from the calculated measured value, i.e., the drag indicator “runs out of control”. Such a case can occur, for example, if the vessel was first filled and this filling process was then terminated. In this case, the slave pointer would continue to move “upwards” and thus indicate that the level is continuing to rise. If a new measurement then shows that this is not the case, but rather that the level is no longer changing, a new measured value (process measurement data) is transmitted to the external receiver.

According to a further embodiment, the computing unit is configured not to instruct the measuring device to transmit process measurement data to the external receiver if the calculated current value of the process measurement variable deviates from the current value of the process measurement variable attributable to the current process measurement data by less than the predetermined threshold.

Thus, if it turns out that the drag pointer continues to provide a good prediction of the level, no new measured value is transmitted.

All this ensures that a measured value is only transmitted if this is also required for readjusting the slave pointer. If, on the other hand, the drag pointer continuously supplies well estimated values for the measured values, no new, current measured values are transmitted.

According to a further embodiment, the approximate calculation of the past temporal development of the value of the process measurement variable comprises the generation of a mathematical or graphical description of the past temporal development. By such a description of the past temporal development it is possible in a simple way to make forecasts for the future or to estimate current measured values.

According to another embodiment, the drag pointer is implemented in a cloud or a user's terminal device.

According to another embodiment, the drag pointer is arranged to wirelessly receive the process measurement data from the measuring device.

According to a further embodiment, the process measurement variable is a level of a container or a volume of a product in a container.

According to a further embodiment, the process measurement data is level measurement data from a level measurement device.

Another aspect of the present disclosure relates to a measuring device, for example a level meter, a point level sensor, a pressure meter or a flow meter, comprising a drag indicator described above and below.

According to another aspect of the present disclosure, there is disclosed a measuring device-external display and/or evaluation unit comprising a drag pointer described above and below.

Another aspect of the present disclosure relates to a method for calculating a process measurand, in which an approximate calculation of a past temporal development of the value of the process measurand is first performed from process measurement data of a measuring device. Thereafter, a calculation of the current value of the process measurand is performed from the past calculated temporal evolution.

Another aspect of the present disclosure relates to a program element which, when executed on the computing unit of a drag pointer, instructs the computing unit to perform the steps described above.

Another aspect of the present disclosure relates to a computer-readable medium on which a program element described above is stored.

### BRIEF DESCRIPTION OF THE DRAWINGS

Further embodiments of the present disclosure are described below with reference to the figures. If the same reference signs are used in the following description of figures, these designate the same or similar elements. The representations in the figures are schematic and not to scale.

FIG. 1 shows measurement intervals of two sensors.

FIG. 2 shows measurement intervals of two sensors.

FIG. 3 shows a level curve over time.

FIG. 4 shows level measurement values for the time curve shown in FIG. 3.

FIG. 5 shows the temporal course of sensor readings as well as an approximately calculated temporal development on these readings.

FIG. 6 shows a measuring system according to an embodiment.

FIG. 7 shows another illustration of a measuring system.

FIG. 8 shows a flow diagram of a process according to an embodiment.

### DETAILED DESCRIPTION OF EMBODIMENTS

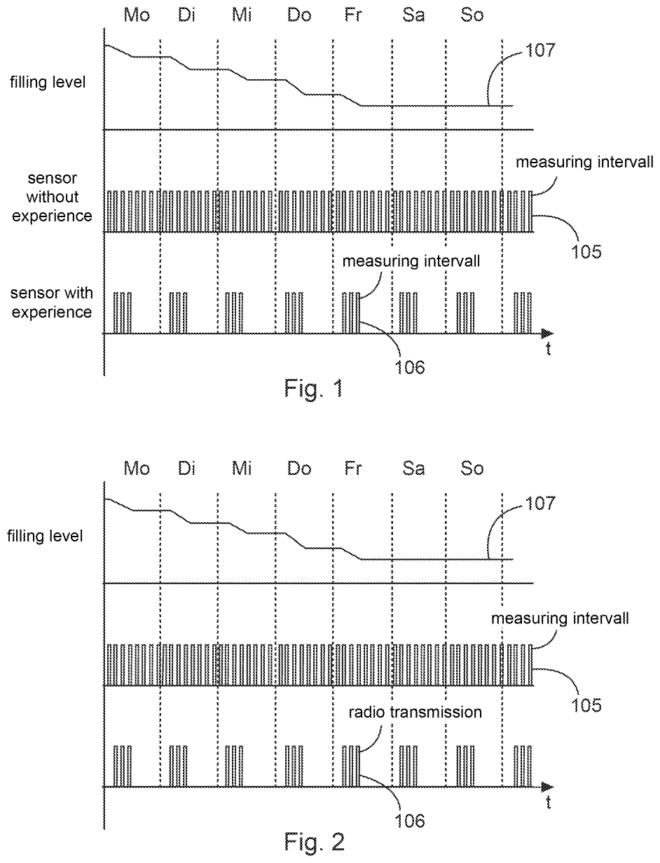

FIG. 1 shows a diagram in which the time course 107 of a filling level over a week can be seen. During the working week Monday to Friday, the fill level decreases gradually and remains constant on Saturdays and Sundays.

Reference numeral 105 shows the time course of measuring intervals of a measuring device (sensor) without experience. The measuring intervals have a constant time interval, regardless of whether the level changes or not.

Reference numeral 106, on the other hand, shows the temporal distribution of measurement intervals of a self-learning sensor that has already gained experience. The self-learning sensor is intelligent enough to determine when the next measurement should be made. Thus, it can save energy by not taking measurements accordingly.

However, if the sensor does not measure a change in the measured value because the distance between adjacent measuring intervals has been increased, rapid level changes can sometimes only be detected late.

FIG. 2 shows a similar diagram to FIG. 1, this time with regard to radio transmission. Reference numeral 107 again shows the actual course of the level and reference sign 105 the measuring intervals. Reference sign 106 shows the phases of transmission of the measured values (radio transmission). The energy required for radio transmission of the measured values is considerable and places a heavy demand on the energy of a self-sufficient sensor. The radio module can now be programmed to be activated for radio transmission in dependence on the measured values, for example in dependence on changes in measured values. With this technique, it is possible to measure the level at regular intervals. However, the measured value is only transmitted to the cloud, for example, in the event of significant changes.

Users who want to read the measured value remotely will not receive any information about level changes during the periods when no measurement or radio transmission is taking place. Consequently, there may be a large difference between the level displayed externally and the actual level.

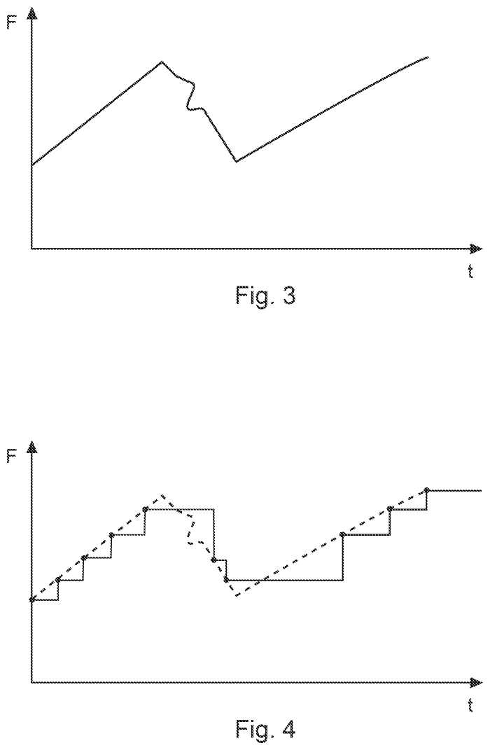

FIGS. 3 and 4 are intended to illustrate how the measured value can be stored in the cloud or on another measuring device of the external memories in a stepwise manner.

FIG. 3 shows the actual development of the fill level over time. The level first rises linearly and then falls again. Then it rises again linearly.

FIG. 4 shows the recorded measured values that can be transferred from the measuring device to the cloud. Since these measured values are only recorded at certain times, the result is a step-shaped progression of the level measurement curve. Since the measured value is therefore displayed to the user directly from the cloud, the user also receives this in a step-shaped manner with the corresponding deviation from the actual value. This deviation can only be reduced by increasing the measurement rate or increasing the radio transmission rate.

However, the deviation can also be reduced by detecting a level pattern or trend in the measuring device, in the central memory (cloud) or in the user's terminal device. Such a level pattern can be, for example, a certain slope of a measurement curve (even an unchanged measured value contains a slope 0). In this case, the external computing unit in the central memory promptly follows the detected level pattern (process measurement pattern or trend) and thus increases the display accuracy for the user.

With this method it is possible to reduce the radio rate while still increasing the displayed measurement accuracy.

Thus, it is possible to save sensor energy since the radio transmission rate can be reduced without the displayed measured value and the actual level differing greatly. In particular, the measuring device can be set up to send measurement data only when the value of the process measurand runs out of tolerance, i.e., moves too far away from the predicted value (“calculated current value of the process measurand”).

The drag pointer has an intelligent measured value memory that predicts or extrapolates as accurately as possible the measured value from past historical data at the current time based on the previous level pattern and/or time (time of day/day of week) and/or weather data.

For example, a (daily) time course of measured values is displayed in the cloud. The display in the cloud follows a trailing pointer, which has learned from historical data how the trend can develop. To save energy from battery-powered sensors, for example, a measured value is only transmitted from the sensor if the measured value deviates significantly from the expected value.

The sensor transmits the measured values via a radio link as soon as the measured value is outside a tolerance band.

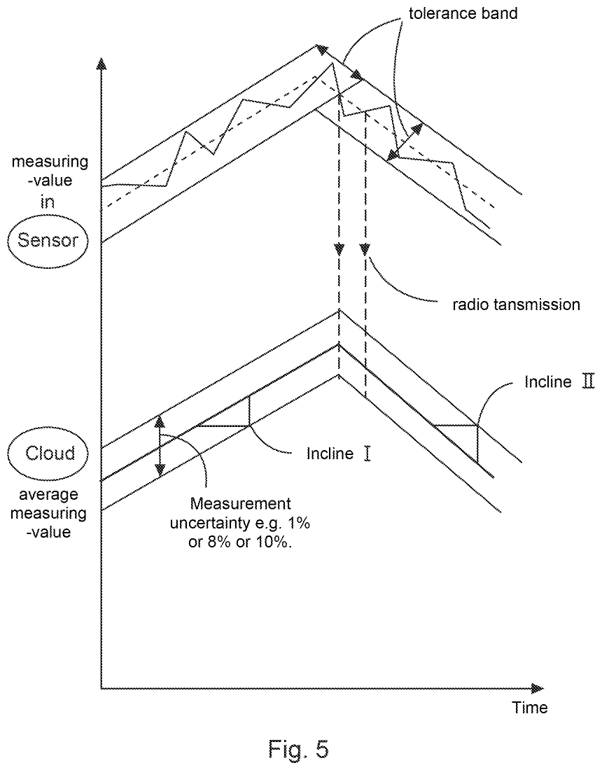

FIG. 5 shows a measured value curve as it is determined in the measuring device. The sensor draws a curve through the measuring points (in this case a jagged curve, since the measured values do not lie on a common straight line) and averages the measured values accordingly (see dashed curve). A tolerance band is placed over this averaging. If a measured value deviates from the averaging to such an extent that a predetermined tolerance range of e.g., 1% or 5% or in non-critical systems 10 to 25% is exceeded, a radio transmission of the measured value to the cloud is initiated. In one example, the cloud is the VEGA Inventory System (VIS). Radio transmission means low-power wide-area communication, such as LoRa or NB-IoT. Short-range communication can also be used, especially within an industrial site, such as Bluetooth or WLAN. Also, transmission can be by means of WirelessHART.

In the cloud, the last received measured value is compared with the historical measurement data. The cloud or a terminal device is able to detect a pattern with this data and adjusts itself the averaging of the measured value and the associated measurement uncertainties. This can be seen in the lower part of FIG. 5.

With the predetermined level pattern, the cloud is now able to determine the future measured value progression and approximate it in the time between the last transmitted measured value and the next transmitted measured value.

For example, a constant slope in the measured value curve can be used as a characteristic value. It is also possible to use the time of day, the day of the week, a valve position or even weather data as characteristic values. Many characteristic values are possible, whereby only an excerpt of the many possibilities is mentioned here.

The tolerance range and the measurement uncertainty may be specified by the manufacturer. However, it is also possible that these can be set by the customer. A self-learning setting is also possible, provided that sufficient data is available.

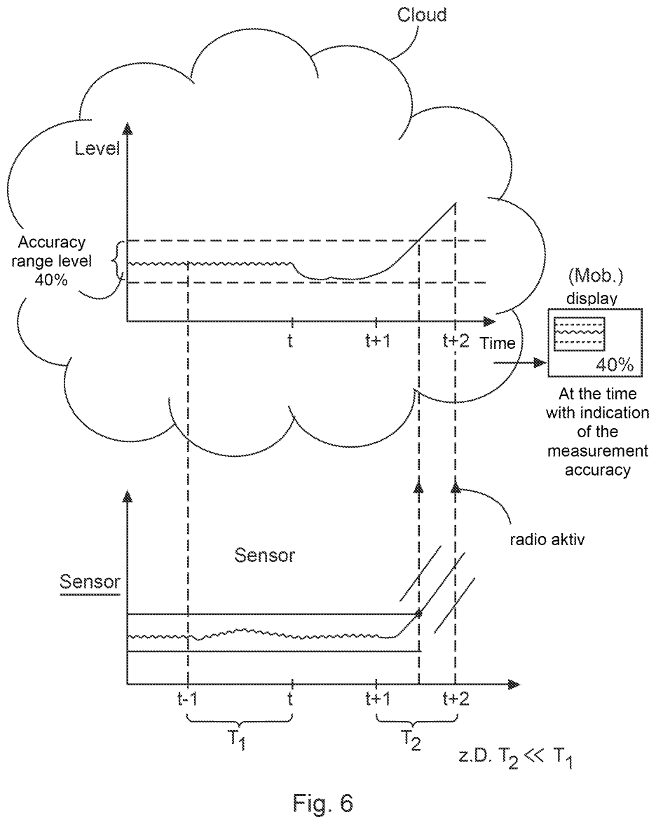

FIG. 6 shows a measuring system which has implemented the method described above. In the lower part of FIG. 6, the measurement curve of a level sensor is shown over time.

This level sensor works autonomously and is therefore battery-powered and sends the measured values via radio to a higher-level central computer. This superordinate central computer is shown in the picture above and is set up like a cloud storage with corresponding intelligence/computing power. An example of such a cloud solution is the VIS.

Users can now access the data in the cloud with their display device. These display devices are, for example, central control systems (PLC), field display devices, such as DIS 82, network-compatible computers, but also mobile PCs, tablets, smartphones or wearables. The display devices are shown on the right in FIG. 6.

In the following, the operation of the measuring system up to time T is described. The sensor monitors a flow level. This flow level is constant over a long period of time. The sensor recognizes that the measured value is largely constant and does not exceed the tolerance threshold. Thus, the sensor reduces the frequency of the radio transmission in order to save energy.

The cloud also detects that the level changes according to a certain pattern or the cloud receives this pattern from the sensor. The cloud thus updates the measured value since the last measured value at time (T−1) up to time (T) with the known pattern.

A user reading the measured value on the display device sees at the time between (T−1) and T the level approximated with the pattern and, if necessary, the measurement accuracy.

In the following, the mode of operation from time (T+1) is described. In the example of river level monitoring, the level now suddenly rises sharply due to heavy rain. The sensor detects that the measured value is outside the tolerance range. It causes the radio module to send the measured value to the cloud.

With the further measurements, the sensor tries to detect a new pattern and to redefine the tolerance range in order to reduce the energy-intensive radio transmission again.

A new current measured value arrives in the cloud at time (T+1). The cloud computer leaves the known pattern for mean value calculation and adjusts the new mean value accordingly. With a new measured value at time (T+2), the cloud computer attempts to recognize a new pattern and follows this until the next measured value transmission.

The user receives an approximated actual measured value extrapolation up to time T+1. From the time at which the measured value leaves the tolerance, the user may receive a warning message. From this time T+1, the display at the user is also adjusted and the user receives the level values that are always as accurate as possible with maximum energy saving function.

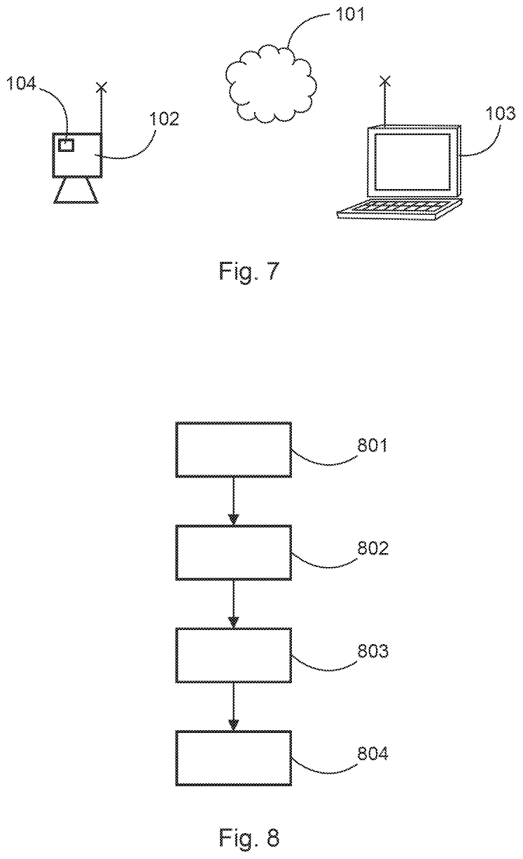

FIG. 7 shows another embodiment of the measurement system. The measurement system has a measurement device 102 with a computing unit 104. This measuring device can communicate with the cloud 101. Furthermore, an external display and/or control unit 103 is provided, which can also communicate with the cloud. The drag pointer may be built into the measuring device 102 as well as into the cloud 101 or the user-side terminal device 103.

FIG. 8 shows a flow diagram of a process according to an embodiment. In step 801, process measurement data is acquired by a measuring device. A computing unit, which can be located directly in the measuring device, in the cloud or in a user terminal, calculates process measurement variables from this acquired process measurement data and then calculates an approximation function from these process measurement variables, which in a graphical representation produces a continuous curve that approximates the measured values in the form of averaging (step 802). In step 803, a further measured value is now estimated from this by continuing this averaging over time. In other words, a current value of the process measurement variable is calculated (but not measured) from the past development of the process measurement variable over time.

In step 804, this calculated, theoretical value is now compared with an actual measured value and a decision is made as to whether a new measured value must be transmitted or not. The former will be the case if the difference between the predicted measured value and the actual measured value exceeds a certain threshold, and vice versa.

This allows the frequency of radio transmission to be reduced, resulting in significant energy savings.

Supplementally, it should be noted that “comprising” and “having” do not exclude other elements or steps, and the indefinite articles “a” or “an” do not exclude a plurality. It should further be noted that features or steps that have been described with reference to any of the above embodiments may also be used in combination with other features or steps of other embodiments described above. Reference signs in the claims are not to be regarded as limitations.

1. A drag pointer configured to calculate a process measurement variable, comprising:
computing circuitry configured to
approximate calculation of a past temporal development of a value of the process measurement variable from process measurement data of a measuring device, and
calculate a current value of the process variable from the past temporal development.

2. The drag pointer according to claim 1,
wherein the approximate calculation of the past temporal development of the value of the process measurement variable includes identifying a process measurement variable pattern or trend.

3. The drag pointer according to claim 1,
wherein the computing circuitry is further configured to compare the calculated current value of the process measurement variable with a current value of the process measurement variable attributable to current process measurement data.

4. The drag pointer according to claim 1,
wherein the computing circuitry is further configured to instruct the measuring device to transmit process measurement data to an external receiver when the calculated current value of the process measurement variable deviates from the current value of the process measurement variable attributable to the current process measurement data by more than a predetermined threshold value.

5. The drag pointer according to claim 1,
wherein the computing circuitry is further configured to not instruct the measuring device to transmit process measurement data to an external receiver when the calculated current value of the process measurement variable deviates from the current value of the process measurement variable attributable to the current process measurement data by less than a predetermined threshold value.

6. The drag pointer according to claim 1,
wherein the approximate calculation of the past temporal development of the value of the process measurement variable comprises generating a mathematical or graphical description of the past temporal development.

7. The drag pointer according to claim 1,
wherein the drag pointer is implemented in a cloud or a terminal of a user.

8. The drag pointer according to claim 1,
wherein the process measurement data is wirelessly transmitted from the measuring device to the drag pointer.

9. The drag pointer according to claim 1,
where the process variable is a level of a container or a volume of a product.

10. The drag pointer according to claim 1,
wherein the process measurement data is level measurement data from a level measurement device.

11. A measuring device comprising:
the drag pointer according to claim 1.

12. A measuring device-external display and/or evaluation circuitry, comprising:
the drag pointer according to claim 1.

13. A method for calculating a process measured variable, comprising:
approximately calculating a past temporal development of a value of a process measurement variable from process measurement data of a measuring device; and
calculating a current value of the process measurement variable from the past temporal development.

14. A non-transitory computer readable medium having stored thereon a program element which, when executed on computing circuitry of a drag pointer, instructs the computing circuitry to be configured to:
approximately calculate a past temporal development of a value of a process measurement variable from process measurement data of a measuring device, and
calculate a current value of the process measurement variable from the past temporal development.

15. The drag pointer according to claim 2,
wherein the computing circuitry is further configured to compare the calculated current value of the process measurement variable with a current value of the process measurement variable attributable to current process measurement data.

16. The drag pointer according to claim 2,
wherein the computing circuitry is further configured to instruct the measuring device to transmit process measurement data to an external receiver when the calculated current value of the process measurement variable deviates from the current value of the process measurement variable attributable to the current process measurement data by more than a predetermined threshold value.

17. The drag pointer according to claim 3,
wherein the computing circuitry is further configured to instruct the measuring device to transmit process measurement data to an external receiver when the calculated current value of the process measurement variable deviates from the current value of the process measurement variable attributable to the current process measurement data by more than a predetermined threshold value.

18. The drag pointer according to claim 2,
wherein the computing circuitry is further configured to not instruct the measuring device to transmit process measurement data to an external receiver when the calculated current value of the process measurement variable deviates from the current value of the process measurement variable attributable to the current process measurement data by less than a predetermined threshold value.

19. The drag pointer according to claim 3,
wherein the computing circuitry is further configured to not instruct the measuring device to transmit process measurement data to an external receiver when the calculated current value of the process measurement variable deviates from the current value of the process measurement variable attributable to the current process measurement data by less than a predetermined threshold value.

20. The drag pointer according to claim 4,
wherein the computing circuitry is further configured to not instruct the measuring device to transmit process measurement data to an external receiver when the calculated current value of the process measurement variable deviates from the current value of the process measurement variable attributable to the current process measurement data by less than a predetermined threshold value.
